(19) United States
(12) Patent Application Publication
(10) Pub. No.: US 2025/0196302 A1
(43) Pub. Date: Jun. 19, 2025

(54) Oil Filter Wrech

(71) Applicant: Robert Bosch GmbH, Stuttgart (DE)

(72) Inventors: Michael White, Montgomery City, MN (US); Robert Kochie, Dodge Center, MN (US); Daniel Newkirk, Owtonna, MN (US)

(21) Appl. No.: 18/540,112

(22) Filed: Dec. 14, 2023

(51) Int. Cl. B25B 27/00; B25B 13/48; B25B 13/50; B25B 23/142

(52) U.S. Cl. CPC B25B 27/0042; B25B 13/5008; B25B 23/1427; B25B 13/481

(57) ABSTRACT

A wrench for automotive service, and in particular for service involving oil filters. The wrench comprises a torque head, torque handle, and a bracing member. The bracing member engages with the torque head to position the wrench with respect to a target body, such as an oil filter. The torque handle engages with the torque head to transfer torque from the torque handle to the torque head. The torque head is configured to transfer torque to the target body via grip surface. Additional features may provide additional functionality.

### TECHNICAL FIELD

This disclosure relates to handheld tools. More particularly, this disclosure relates to handheld tools for automotive service.

### BACKGROUND

Motor vehicles utilizing engine oil must be regularly serviced, including changing of the engine oil. Vehicles utilizing engine oil will make use of an oil filter to help protect the engine from contaminants. During service of the engine that requires removal of the oil filter, oil may spill down the sides of the filter. In professional service settings, the engine may have been recently operating, and the oil may be hot. Thus, spillage of the oil is undesirable for reasons of safety for a service user as well as preventing a mess requiring cleanup.

What is desired is a tool that will aid in oil filter removal without exposing the service user to hot oil. It is additionally desired for a tool that will minimize or contain oil spillage during service of the vehicle.

### SUMMARY

One aspect of this disclosure is directed to a wrench comprising a torque handle, a torque head, and a bracing member. The torque head is configured to detachably couple to the torque handle. The bracing member is configured to detachably couple to the torque head. The torque head comprises a grip surface configured to engage a target body and transfer torque to the target body when torque is applied to the torque head by the torque handle during a coupling of the torque handle and the torque head. The torque head comprises an interface configured to engage with the bracing member, the interface configured to couple with the bracing member and the torque head without impeding rotation of the torque head. The bracing member further comprises a proximal end and a distal end, the distal end being configured to engage the bracing interface. The grip surface may be concave, textured, or both concave and textured. The torque head may comprise one or more magnets configured to magnetically engage with a target body during engagement between the torque head and the target body. In some embodiments, the torque head may comprise a sidewall extension extending from the grip surface along at least a portion of the perimeter of the torque head. The torque handle may comprise a square drive. The torque handle may comprise a flexible neck configured to deform under a predetermined load. In such embodiments, the flexible neck is further configured to transfer torque to the torque head when deformed.

Another aspect of this disclosure is directed to a torsion assembly comprising a torque head and a bracing member. The torque head is configured to detachably couple to a torque handle. The bracing member is configured to detachably couple to the torque head. The torque head comprises a grip surface configured to engage a target body and transfer torque to the target body when torque is applied to the torque head by the torque handle during a coupling of the torque handle and the torque head. The torque head comprises an interface configured to engage with the bracing member. The interface is configured to couple with the bracing member and the torque head without impeding rotation of the torque head. The bracing member comprises a proximal end and a distal end, the distal end being configured to engage the bracing interface. The grip surface may be concave, textured, or both concave and textured. The torque head may comprise one or more magnets configured to magnetically engage with a target body during engagement between the torque head and the target body. In some embodiments, the torque head may comprise a sidewall extension extending from the grip surface along at least a portion of the perimeter of the torque head. In some embodiments, the perimeter of the torque head is circular from a view perpendicular to the grip surface. In some embodiments, the distal end of the bracing member comprises a plurality of prongs. In some embodiments the bracing member comprises a hinge disposed between the proximal end and the distal end.

A further aspect of this disclosure is directed to a wrench torque head comprising a body, a grip surface, and an interface. The grip surface is disposed upon the body and has a texture. The interface is at least partially disposed upon the body opposite the grip surface and configured to engage with a bracing member separate from the torque head. The grip surface is configured to engage with a target body. The interface is configured to engage a torque handle. The torque head is configured to transfer torque from a torque handle to the target body when the grip surface engages with the target body and the interface engages with the torque handle and receives torque from the torque handle. The grip surface may be concave, textured, or both concave and textured. The torque head may comprise one or more magnets configured to magnetically engage with a target body during engagement between the torque head and the target body. In some embodiments, the torque head may comprise a sidewall extension extending from the grip surface along at least a portion of the perimeter of the torque head. In some embodiments, the bracket receives a torque handle, separate from the torque head, via a square drive receiver.

The above aspects of this disclosure and other aspects will be explained in greater detail below with reference to the attached drawings.

### BRIEF DESCRIPTION OF THE DRAWINGS

FIG. 1 is a diagrammatic view of an oil change service operation for a vehicle.

FIG. 2 is a view of an oil filter cartridge of a vehicle in-situ from an underside perspective.

FIG. 3 is an exploded view of a wrench.

FIG. 4 is an assembled view of the wrench of FIG. 3.

FIG. 5 is an exploded view of a wrench.

FIG. 6 is an assembled view of the wrench of FIG. 5

FIG. 7 is a side view of a torque head of a wrench.

FIG. 8 is a side view of a torque head of a wrench.

FIG. 9 is an alternative view of the torque head of FIG. 8.

FIG. 10 is a side view of a torque head of a wrench with a sidewall extension element.

FIG. 11 is an isometric view of a bracing member of a wrench.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

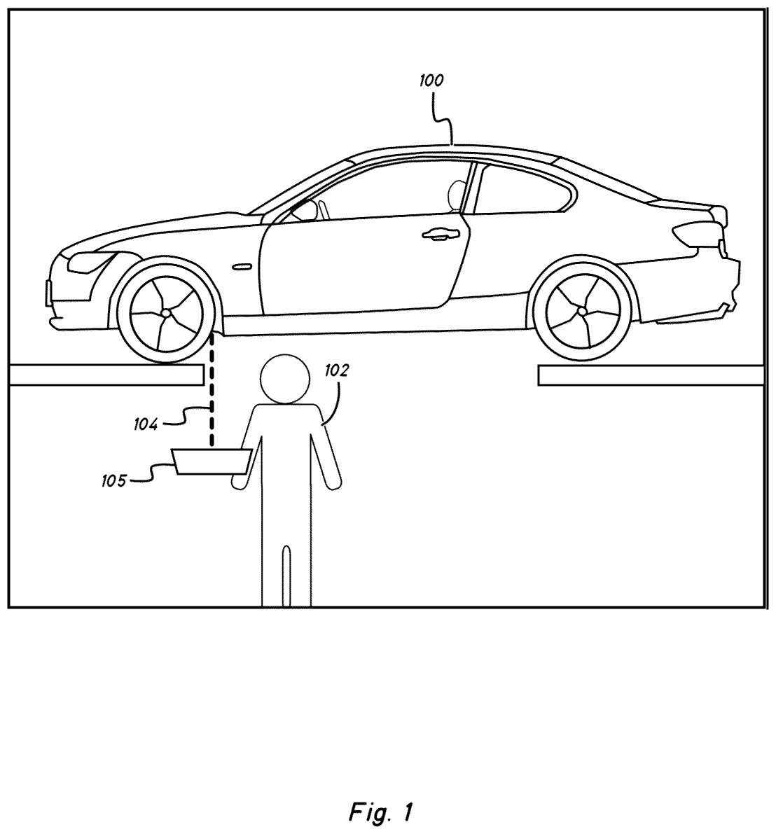

FIG. 1 is a diagrammatic depiction of an oil change service for a vehicle 100 by a service user 102 in a professional setting. The motor oil of vehicle 100 is released via oil drainage 104 into a collection receptacle 105. In a professional setting, vehicle 100 may be serviced rapidly upon arrival to the location of service, and as a result, fluids within vehicle 100 may be hot. Additionally, fluids such as motor oil spill during service, creating messy conditions for service user 102. These service operations must therefore be accomplished with care in order to optimize safety of service worker 102.

In the depicted embodiment, vehicle 100 comprises a consumer sedan, but other embodiments may comprise other vehicles without deviating from the teachings disclosed herein. Such embodiments may comprise a coupe, compact car, motorcycle, motor scooter, cargo van, minivan, truck, light truck, sport-utility vehicle, crossover vehicle, limousine, or any other vehicle utilizing one or more fluids that may require interaction by a service user during a service operation.

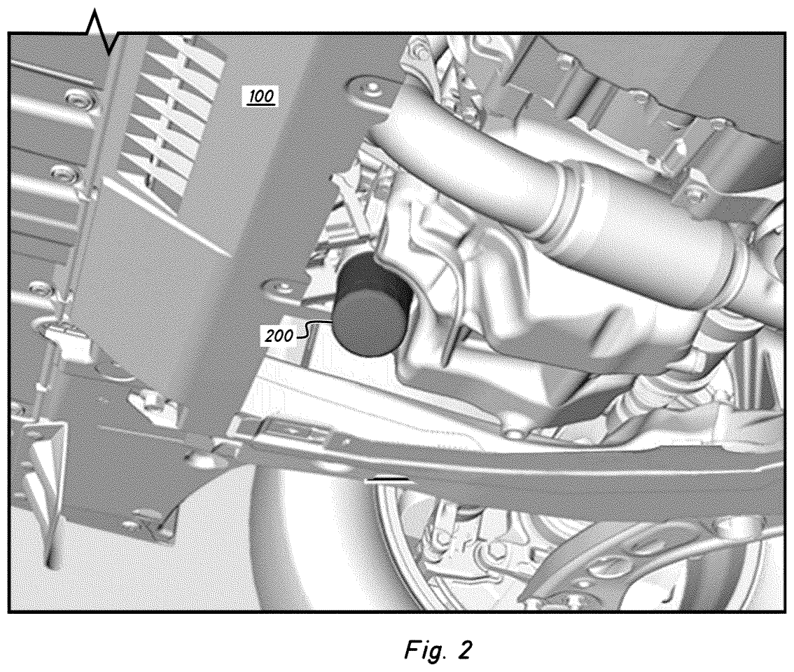

During a service operation of an oil change, an oil filter of vehicle 100 may be removed, which may additionally be source of oil drainage 104. Because service user 102 is below vehicle 100 during the service operation for convenience of the customer, gravity is a concern for oil drainage 104, as the motor oil (or other fluids) may drain towards service user 102. Other conditions are a consideration for the service of oil changes in vehicle 100. FIG. 2 is a depiction of vehicle 100 from a bottom-up perspective, looking at its oil filter cartridge (often simplified to “oil filter”) 200 in situ. The placement of oil filter 200 may be difficult for service user 102 to screw or unscrew oil filter 200 with bare hands because of tight working spaces along the under-carriage of vehicle 100. A tool is desired to provide a user with a way of handling and maneuvering the oil filter 200 without directly interacting with any component of vehicle 100 by hand.

In the depicted embodiment, oil filter 200 is disposed along the under-carriage of vehicle 100 with a downward-facing orientation, but other embodiments may comprise an oil filter disposed differently within a vehicle or oriented differently without deviating from the teachings disclosed herein.

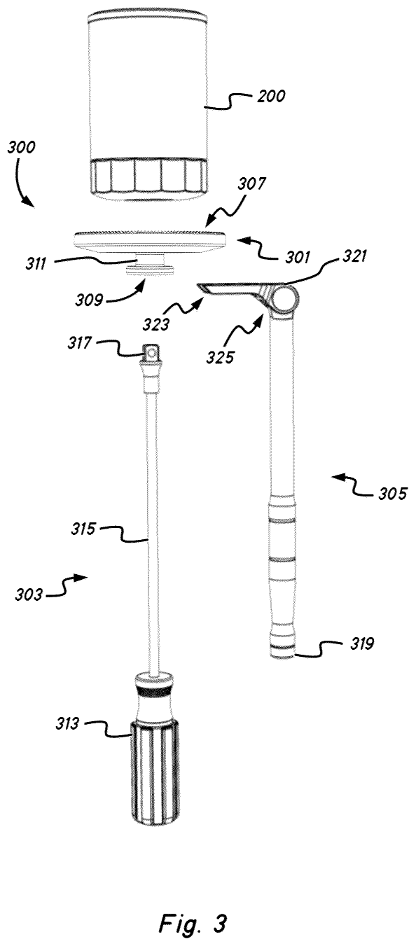

FIG. 3 is an exploded view of a wrench 300 suitable for applying torque to oil filter 200 in order to couple or de-couple the oil filter 200 to an associated port of a vehicle (such as vehicle 100, see FIG. 1, FIG. 2). Wrench 300 comprises a torsion assembly of multiple parts, including a torque head 301, a torque handle 303, and a bracing member 305.

Torque head 301 comprises a grip surface 307 configured to engage a target body (such as oil filter 200) during a transfer of torque from wrench 300 to the target body. Torque head additionally comprises a handle receptacle 309 configured to detachably couple torque head 301 with torque handle 303. Torque view additionally comprises an interface 311 configured to detachably couple torque head 301 with bracing member 305.

When assembled, torque can be applied to torque head 301 via torque handle 303. Torque handle 303 comprises a grip 313 to optimize a user's ability to manually provide torque via wrench 300. Torque is transferred from the grip 313 to the torque head 301 via a neck 315. In the depicted embodiment, neck 315 comprises a flexible neck that is configured to deform under a predetermined load. In the depicted embodiment, a predetermined load may be on the order of a user applying manual force to shape flexible neck 315, but other embodiments may comprise other configurations without deviating from the teachings disclosed herein. Flexible neck 315 is further configured to transfer torque when deformed. Torque handle 303 further comprises a bit 317 configured to engage with the handle receptacle 309 of torque head 301. In the depicted embodiment, bit 317 comprises a half-inch square bit with a retention ball, but other embodiments may comprise other configurations without deviating from the teachings disclosed herein.

Bracing member 305 comprises a proximal end 319 and a distal end 321. Proximal end 319 is configured to permit a user to manipulate bracing member 305 and distal end 321 is configured to engage with the interface 311 of torque head 301. In the depicted embodiment, distal end 321 comprises a plurality of prongs 323 suitable to detachably couple with the interface 311. In this embodiment, interface 311 comprises a notch channel sized appropriately to engage with prongs 323. This engagement allows a user to utilize bracing member 305 to position torque head 301 with respect to a target body prior to applying torque without placing their hands near the target body or the mechanical environment of a vehicle (such as vehicle 100; see FIG. 2) surrounding the target body. The engagement of prongs 323 with interface 311 is configured such that rotational motion of torque head 301 is not impeded by the engagement, which advantageously permits a user to utilize bracing member 305 to stabilize the engagement of torque head 301 with a respective target body (such as oil filter 200) during application of torque.

The extension provided by bracing member 305 to position torque head 301 is additionally advantageous because it more easily permits a user to see the placement of the torque head 301 with respect to a target body without contorting their body uncomfortably, as they would need to do if using their hands. Bracing member 305 additionally comprises a hinge 325 suitable to adjust the angle of bracing member 305 with respect to torque head 301 when coupled, enhancing the ergonomic utility and visibility for a user during operation of wrench 300.

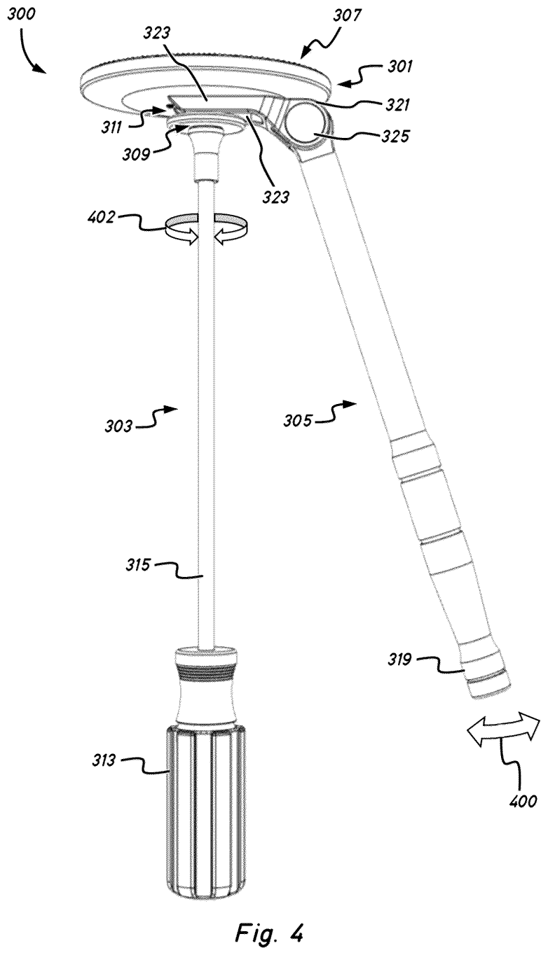

FIG. 4 is an assembled view of wrench 300. In this arrangement, wrench 300 is suitable to engage with a target body and apply torque. In this view, torque head 301 is coupled to torque wrench 303 and bracing member 305. The bit 317 (not visible; see FIG. 3) has been inserted into handle receptacle 309, transmitting torque from torque handle 303 to torque head 301. At the same time, prongs 323 or bracing member 305 have engaged with interface 311, enabling placement of torque head 301 by a user from the distal end 319. Hinge 325 enables angular adjustment of bracing member 305 with respect to the rest of wrench 300 along rotational direction 400. The engagement of prongs 323 and interface 311 permits motion of bracing member 305 in a rotational direction 402 about an axis defined by the torque handle 303. This rotational engagement enables both optimal placement of torque head 301 utilizing bracing member 305, but also optimal transfer of torque from torque handle 303 to torque head 301. The torque is then transferred from torque head 301 to a target body (not shown; see FIG. 3).

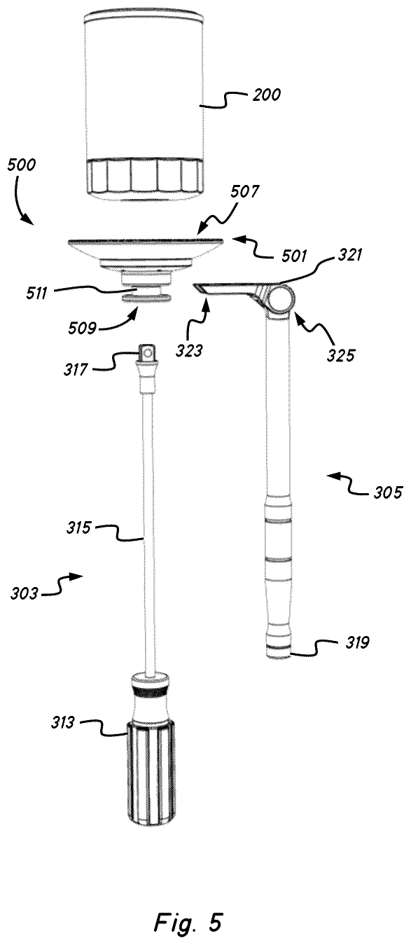

FIG. 5 comprises an exploded view of an alternative embodiment comprised of wrench 500. In this embodiment, wrench 500 comprises an identical torque handle 303 and bracing member 305, but an alternative configuration of a torque head 501. In this embodiment, torque head 501 comprises a concave grip surface 507, which advantageously provides enhanced engagement with a target body during operation. Handle receptacle 509 and interface 511 are functionally identical to handle receptacle 309 and interface 311, resulting in identical functionality of these elements of wrench 500 when compared with the functionality of wrench 500.

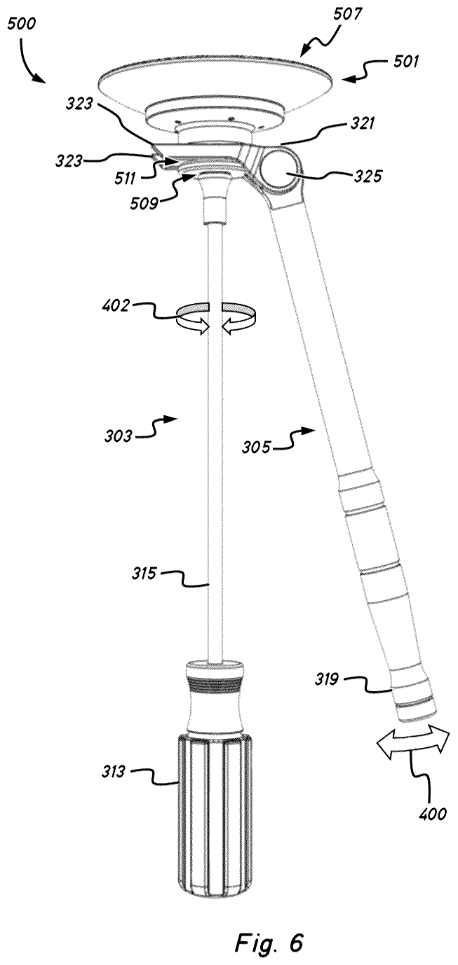

FIG. 6 is an assembled view of wrench 500. In this view, torque head 501 is coupled to torque wrench 303 and bracing member 305. As shown here, the same functionality with respect to positional adjustment of the elements of wrench 500 is observed when compared with wrench 400, but the exact placement of the torque handle 303 and bracing member 305 with respect to torque head 501 is different to accommodate for the different dimensions of torque head 501 compared to torque head 301.

Additional features of the torque heads of both embodiments may further advantageously improve functionality of each wrench embodiment.

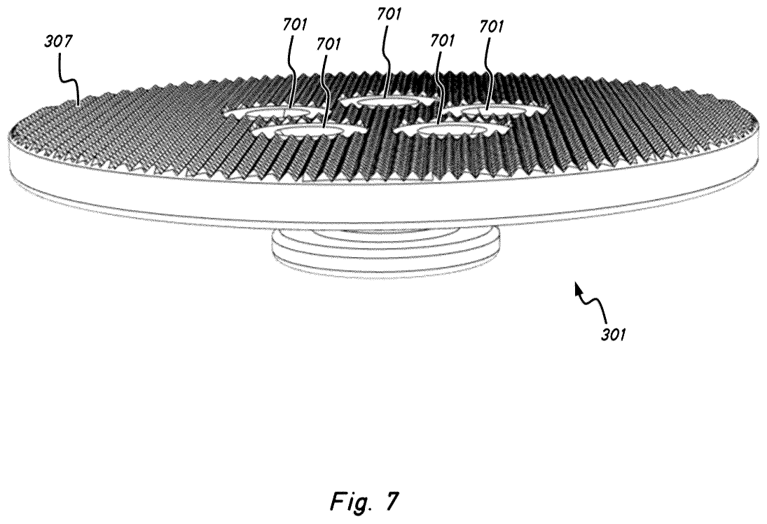

FIG. 7 is a closeup perspective of additional elements of torque head 301 (see also FIG. 3). In this embodiment, it is observed that grip surface 307 comprises a textured surface. Although in this embodiment the texture comprises a regular ridged shape for grip surface 307, other embodiments may comprise other configurations or arrangements without deviating from the teachings disclosed herein. In some embodiments, irregular or different shaped textures may be utilized without deviating from the teachings disclosed herein. In the depicted embodiment, the texture is formed by a regular grid pattern, but other embodiments may make use of other arrangements without deviating from the teachings disclosed herein, such as linear striations (i.e., “stripes” of textured surfaces), wavy striations, angled striations, curved striations, checkboard, or any other textural patterns recognized by one of ordinary skill in the art without deviating from the teachings disclosed herein.

Torque head 301 additionally comprises a plurality of magnets 701. Each of magnets 701 is configured to magnetically engage with a target body having ferromagnetic properties during engagement of torque head 301 and a target body. The magnetic engagement of each of the magnets 701 can advantageously assist a user in stabilizing the engagement of torque head 301 with a target body, and may additionally advantageously optimize control of a target body having ferromagnetic properties that has been loosened from its in situ position. By way of example, and not limitation, an oil filter (such as oil filter 200; see FIG. 2) having ferromagnetic properties may be less likely to fall away from the torque head 301 once it has been unscrewed from its operating position within the associated vehicle (such as vehicle 100; see FIG. 1, FIG. 2). This additional control of a loose target body may additionally minimizing spillage of fluids during service operations. In an additional advantage, the texture of grip surface 307 may retain a higher degree of engagement in the event that a fluid (such as motor oil) is spilled on the surface when compared to a smooth grip surface.

In the depicted embodiment, torque head 301 comprises 5 magnets of regular dimensions disposed such about a center point of grip surface 307, but other embodiments may comprise other configurations without deviating from the teachings disclosed herein. Some embodiments may comprise a different number of magnets, a plurality of magnets having varying dimensions or shapes, or a different placement of magnets without deviating from the teachings disclosed herein. Some embodiments may not comprise any of magnets 701 without deviating from the teachings disclosed herein. In the depicted embodiment, each of magnets 701 is affixed to torque head 301 via a recess within grip surface 307, but other embodiments may comprise other configurations without deviating from the teachings disclosed herein.

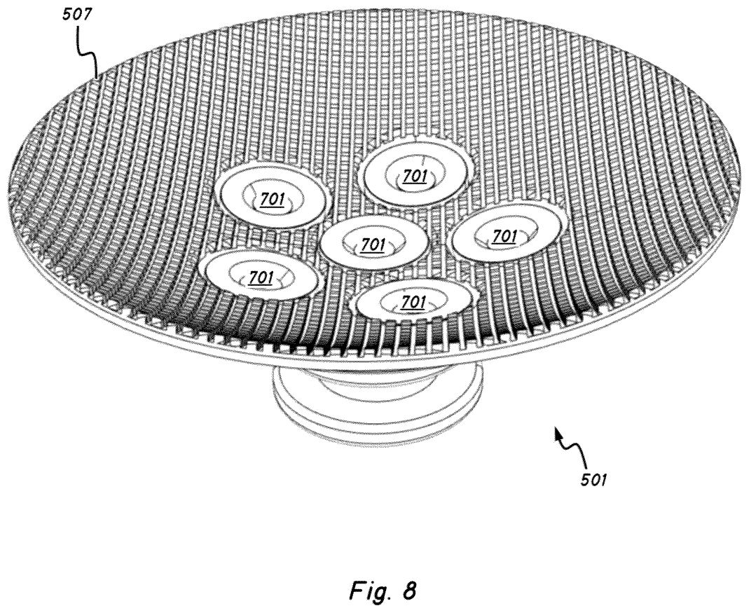

FIG. 8 is a closeup perspective of additional elements of torque head 501 (see also FIG. 5). In this embodiment, it is observed that grip surface 507 comprises a concave and textured surface. Grip surface 507 may be concave with a radius of 0.1 to 5 inches, but other embodiments may comprise other concave radii without deviating from the teachings disclosed herein. It is noted that a longer radius of the concave curvature increases the depth of grip surface 507, and similarly increases the total height of torque head 501. Thus, care must be taken to select an appropriate radius for the vehicles expected to be serviced so that torque head 501 is not too large to provide accessibility to a target body of the vehicle under service (such as oil filter 200; see FIG. 2). In the depicted embodiment, the perimeter of torque head 501 additionally comprises the shape of a circle when viewed from a “top-down” perspective perpendicular to grip surface 501, but other embodiments may comprise other shapes and cross sections without deviating from the teachings disclosed herein. In some such embodiments, torque head 501 may comprise a grip surface 507 in a shape that is configured to perfectly match a particular target body, such as the shape and dimensions of a particular oil filter used by one manufacturer of vehicles. However, the circular shape of torque head 501 advantageously provides compatibility with a broad range of target bodies.

Although in this embodiment the texture comprises a regular ridged shape for grip surface 507, other embodiments may comprise other configurations or arrangements without deviating from the teachings disclosed herein. In some embodiments, irregular or different shaped textures may be utilized without deviating from the teachings disclosed herein. In the depicted embodiment, the texture is formed by a regular grid pattern, but other embodiments may make use of other arrangements without deviating from the teachings disclosed herein, such as linear striations (i.e., “stripes” of textured surfaces), wavy striations, angled striations, curved striations, checkboard, or any other textural patterns recognized by one of ordinary skill in the art without deviating from the teachings disclosed herein.

Similar to torque head 301 (see FIG. 7), torque head 501 additionally comprises a plurality of magnets 701. Each of magnets 701 is configured to magnetically engage with a target body having ferromagnetic properties during engagement of torque head 501 and a target body. The magnetic engagement of each of the magnets 701 can advantageously assist a user in stabilizing the engagement of torque head 501 with a target body, and may additionally advantageously optimize control of a target body having ferromagnetic properties that has been loosened from its in situ position. By way of example, and not limitation, an oil filter (such as oil filter 200; see FIG. 2) having ferromagnetic properties may be less likely to fall away from the torque head 501 once it has been unscrewed from its operating position within the associated vehicle (such as vehicle 100; see FIG. 1, FIG. 2). This additional control of a loose target body may additionally minimizing spillage of fluids during service operations. In an additional advantage, the texture of grip surface 507 may retain a higher degree of engagement in the event that a fluid (such as motor oil) is spilled on the surface when compared to a smooth grip surface.

In the depicted embodiment, torque head 501 comprises 5 magnets of regular dimensions disposed such about a center point of grip surface 507, but other embodiments may comprise other configurations without deviating from the teachings disclosed herein. Some embodiments may comprise a different number of magnets, a plurality of magnets having varying dimensions or shapes, or a different placement of magnets without deviating from the teachings disclosed herein. Some embodiments may not comprise any of magnets 701 without deviating from the teachings disclosed herein. In the depicted embodiment, each of magnets 701 is affixed to torque head 501 via a recess within grip surface 507, but other embodiments may comprise other configurations without deviating from the teachings disclosed herein.

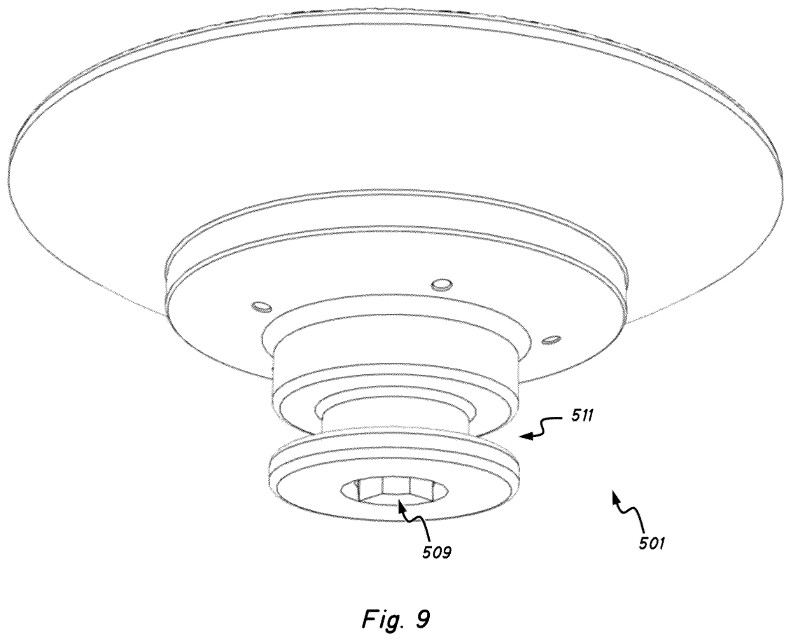

FIG. 9 provides an alternative view of torque head 501, illustrating with greater detail the arrangement of handle receptacle 509 and interface 511. In the depicted embodiment, handle receptacle 509 comprises a half-inch square bit receptacle, but other embodiments may comprise other configurations without deviating from the teachings disclosed herein. In some embodiments, handle receptacle 509 may comprise an adaptable receptacle suitable to receive a number of drive bits having different shapes or sizes without deviating from the teachings disclosed herein.

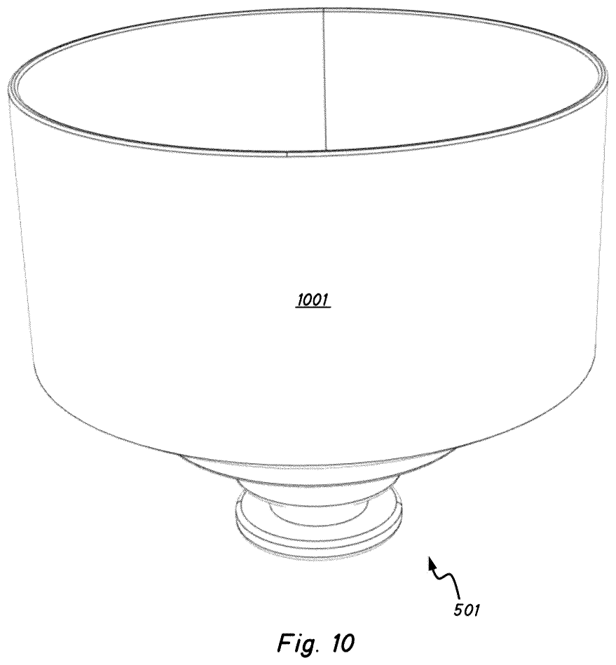

FIG. 10 presents a view of an alternative configuration of torque head 501 additionally comprised of a sidewall extension 1001. Sidewall extension 1001 extends from the grip surface along at least a portion of the perimeter of torque head 501, and in the depicted embodiment it extends around the entire perimeter. Sidewall extension 1001 advantageously helps to contain a loose target body (such as oil filter 200; see FIG. 2) to help protect a user (such as service user 102; see FIG. 1) from the loose target body falling onto them. Additionally, sidewall extension 1001 advantageously helps to prevent falling damage to a loose target body by preventing falls. In an additionally advantage, sidewall extension 1001 also helps to contain any fluids spilled or released during service (such as oil released during loosening of an oil filter), which additionally prevents a mess and protects a user from exposure to the fluids.

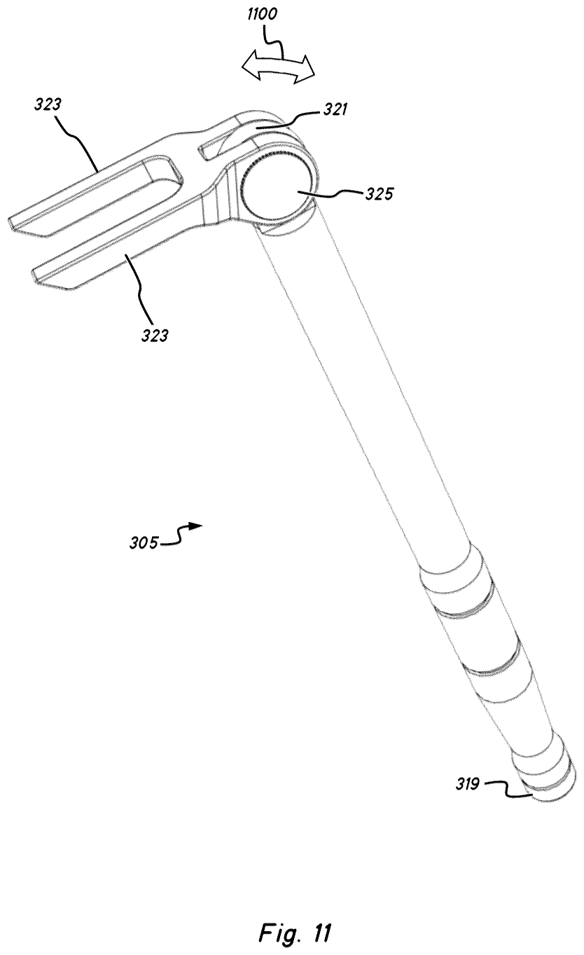

FIG. 11 is an illustration of bracing member 305 showing more detail of features thereof. In the depicted embodiment, bracing member 305 comprises a pair of prongs 323, but other embodiments may comprise a different number of prongs or a different mechanism in the distal end 321 to engage with an interface of a torque head (such as interface 311 of torque head 301 or interface 511 of torque head 501; see FIG. 3, FIG. 5) without deviating from the teachings disclosed herein.

When decoupled from a torque head, hinge 325 permits rotation of prongs 323 in rotational direction 1100. This rotation is fundamentally the same as rotation 400 (see FIG. 4) except from the perspective of a fixed proximal end 319, rather than the perspective of fixed distal end 321, as observed when engaged with a torque head during operation. In practice, hinge 325 permits for adjustment of the relative angle formed between prongs 323 and an axis formed by a line through proximal end 319 and distal end 321.

In this embodiment, hinge 325 is disposed very near the distal end 321, but in other embodiments hinge 325 may be disposed in a different location between proximal end 319 and distal end 321 without deviating from the teachings disclosed herein. Some embodiments may not comprise a hinge 325 without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

1. A wrench comprising:
a torque handle;
a torque head configured to detachably couple to the torque handle; and
a bracing member configured to detachably couple to the torque head,
wherein
the torque head comprises a grip surface configured to engage a target body and transfer torque to the target body when torque is applied to the torque head by the torque handle during a coupling of the torque handle and the torque head,
the torque head comprises an interface configured to engage with the bracing member, the interface configured to couple with the bracing member and the torque head without impeding rotation of the torque head, and
the bracing member comprises a proximal end and a distal end, the distal end being configured to engage the interface.

2. The wrench of claim 1, wherein the grip surface is concave.

3. The wrench of claim 1, wherein the grip surface is textured.

4. The wrench of claim 1, wherein the torque head comprises a magnet, the magnet configured to magnetically engage with a target body during engagement between the torque head and the target body.

5. The wrench of claim 1, wherein the torque head further comprises a sidewall extension, the sidewall extension extending from the grip surface along at least a portion of a perimeter of the torque head.

6. The wrench of claim 1, wherein the torque head detachably couples to the torque handle via a square drive.

7. The wrench of claim 1, wherein the torque handle comprises a flexible neck configured to deform under a predetermined load, the flexible neck further configured to transfer torque to the torque head when deformed.

8. A torsion assembly comprising:
a torque head configured to detachably couple to a torque handle; and
a bracing member configured to detachably couple to the torque head,
wherein
the torque head comprises a grip surface configured to engage a target body and transfer torque to the target body when torque is applied to the torque head by the torque handle during a coupling of the torque handle and the torque head,
the torque head comprises an interface configured to engage with the bracing member, the interface configured to couple with the bracing member and the torque head without impeding rotation of the torque head, and
the bracing member comprises a proximal end and a distal end, the distal end being configured to engage the interface.

9. The torsion assembly of claim 8, wherein the grip surface comprises a concave and textured surface.

10. The torsion assembly of claim 8, wherein the torque head comprises a magnet, the magnet configured to magnetically engage with a target body during engagement between the torque head and the target body.

11. The torsion assembly of claim 8, wherein a perimeter of the torque head is circular from a view perpendicular to the grip surface.

12. The torsion assembly of claim 8, wherein the distal end of the bracing member comprises a plurality of prongs.

13. The torsion assembly of claim 8, wherein the bracing member comprises a hinge disposed between the proximal end and the distal end.

14. A torque head of a wrench comprising:
a body;
a grip surface disposed upon the body, the grip surface having a texture; and
an interface at least partially disposed upon the body opposite the grip surface and configured to engage with a bracing member,
wherein
the grip surface is configured to engage with a target body,
the interface is configured to engage a torque handle, and
the torque head is configured to transfer torque from a torque handle to the target body when the grip surface engages with the target body and the interface engages with the torque handle and receives torque from the torque handle.

15. The torque head of claim 14, wherein the grip surface is concave.

16. The torque head of claim 14, wherein the grip surface is textured.

17. The torque head of claim 14, further comprising a magnet configured wherein the torque head comprises a magnet, the magnet configured to magnetically engage with a target body during engagement between the torque head and the target body.

18. The torque head of claim 17, further comprising a plurality of magnets, each of the magnets configured magnetically engage with a target body during engagement between the torque head and the target body.

19. The torque head of claim 14, further comprising a sidewall extension, the sidewall extension extending from the grip surface along at least a portion of a perimeter of the torque head.

20. The torque head of claim 14, wherein bracket receives a torque handle via a square drive receiver.
